(19) United States
(12) Patent Application Publication
(10) Pub. No.: US 2026/0272052 A1
(43) Pub. Date: Sep. 17, 2026

(54) CONTROL METHOD FOR AEROSOL GENERATING DEVICE, AND AEROSOL GENERATING DEVICE AND SYSTEM

(71) Applicant: SHENZHEN FIRST UNION TECHNOLOGY CO., LTD., Shenzhen, Guangdong (CN)

(72) Inventors: Xinjun LI, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/162,002

(22) PCT Filed: Mar. 1, 2024
(86) PCT No.: PCT/CN2024/079604

§ 371 Date: Sep. 3, 2025

(30) Foreign Application Priority Data
Mar. 3, 2023 (CN) 202310240606.1

(51) Int. Cl. A24F 40/57; A24F 40/20; A24F 40/60; G01D 5/30

(52) U.S. Cl. CPC A24F 40/57; A24F 40/20; A24F 40/60; G01D 5/30

(57) ABSTRACT

An aerosol generating device, a control method for an aerosol generating device, and an aerosol generating system are provided. The aerosol generating system includes the aerosol generating device and an aerosol generating product. The aerosol generating device includes a housing, a chamber, an atomization element, and a color detection device. The housing is provided with an opening. The aerosol generating device has a chamber that can accommodate the aerosol generating product. The aerosol generating device can be inserted into or removed from the chamber through the opening. The chamber is in communication with the outside through the opening. In the control method, the aerosol generating device controls a light source to emit light in an intermittent light emitting mode during at least a part of working time after the light source is turned on.

This application claims priority to Chinese Patent Application No. 202310240606.1, filed with the China National Intellectual Property Administration on Mar. 3, 2023 and entitled “CONTROL METHOD FOR AEROSOL GENERATING DEVICE, AND AEROSOL GENERATING DEVICE AND SYSTEM”, which is incorporated by reference in its entirety.

### TECHNICAL FIELD

Embodiments of this application relate to the field of aerosol generating technologies, and in particular, to a control method for an aerosol generating device, and an aerosol generating device and system.

### BACKGROUND

To automatically turn on an aerosol generating device, an insertion situation or a removal situation of an aerosol generating product in a chamber can be detected through a color detection device, and whether to start or stop heating is determined according to the insertion or removal situation. However, an existing color detection device includes a light source that continuously emits light and a color sensor, and luminous efficiency of the light source decreases as use time increases. When the color detection device performs detection, if an operating mode of the light source is a continuous light emitting mode, not only power consumption is wasted, but also a service life of the light source is shortened.

### SUMMARY

Embodiments of this application provide a control method for an aerosol generating device, and an aerosol generating device and system, to control an operating mode of a light source to be an intermittent light emitting mode during at least a part of operating time, thereby reducing a light emitting time of the light source, which is beneficial to extending a service life of the light source and reducing power consumption.

According to a first aspect of this application, a control method for an aerosol generating device is provided, the method is applied to an aerosol generating device, and the aerosol generating device includes a housing, a light source, and a color sensor. The housing is provided with an opening, the aerosol generating device receives or removes an aerosol generating product through the opening, the aerosol generating product is configured to generate an aerosol under an action of an atomization element, the light source is configured to emit emitted light, and the color sensor is configured to detect a reflected light of the emitted light to generate a color signal. In this method, the aerosol generating device can control the light source to emit light in an intermittent light emitting mode during at least a part of operating time after the light source is turned on. In addition, the aerosol generating device obtains the color signal through the color sensor during the intermittent light emitting mode of the light source, and controls, based on the color signal, a heater to be turned on and/or turned off.

In this embodiment of this application, the aerosol generating device may control the light source to emit light in the intermittent light emitting mode during at least a part of operating time after the light source is turned on, to prevent the light source from continuously emitting light to the outside after the light source is turned on, thereby reducing a light emitting time of the light source, which is beneficial to maintaining a long-term stability of brightness of the light source, extending a service life of the light source, and reducing power consumption.

In some embodiments, the aerosol generating product includes a solid-state aerosol forming substrate, an atomization element includes a heater, a chamber configured to accommodate the aerosol generating product is arranged in the housing, and the heater is configured to heat the aerosol generating product received in the chamber, to enable the solid-state aerosol forming substrate to generate an aerosol, and the controlling the light source to emit light in an intermittent light emitting mode during at least a part of operating time after the light source is turned on specifically includes: obtaining the color signal through the color sensor; and if the obtained color signal is a first color signal, controlling the heater to be turned on, and controlling the light source to emit light in the intermittent light emitting mode, where the first color signal is configured to indicate that the aerosol generating product is inserted into the chamber in position.

In some embodiments, the step of controlling the heater to be turned on, and controlling the light source to emit light in the intermittent light emitting mode includes: synchronously controlling the heater to be turned on and controlling the light source to emit light in the intermittent light emitting mode; or controlling the heater to be turned on, and controlling the light source to emit light in the intermittent light emitting mode within a preset first duration threshold when the heater is turned on.

In some embodiments, the step of obtaining the color signal through the color sensor during the intermittent light emitting mode of the light source, and controlling, based on the color signal, a heater to be turned on and/or turned off includes: obtaining the color signal through the color sensor during the intermittent light emitting mode of the light source; and if the obtained color signal is a second color signal, controlling the heater to be turned off, and controlling the light source to be turned off, where the second color signal is configured to indicate that the aerosol generating product is removed from the chamber.

In some embodiments, the controlling the heater to be turned off, and controlling the light source to be turned off includes: synchronously controlling the heater to be turned off, and controlling the light source to be turned off; or controlling the heater to be turned off, and controlling the light source to be turned off within a preset second duration threshold when the heater is turned on.

In some embodiments, the aerosol generating product includes a solid-state aerosol forming substrate, the atomization element includes a heater, a chamber configured to accommodate the aerosol generating product is arranged in the housing, and the heater is configured to heat the aerosol generating product received in the chamber, to enable the solid-state aerosol forming substrate to generate an aerosol; and the controlling the light source to emit light in an intermittent light emitting mode during at least a part of operating time after the light source is turned on includes: obtaining a turn-on signal of the light source; and controlling, in response to the turn-on signal, the light source to emit light in the intermittent light emitting mode. The step of obtaining the color signal through the color sensor during the intermittent light emitting mode of the light source, and controlling, based on the color signal, a heater to be turned on and/or turned off includes: obtaining the color signal through the color sensor during the intermittent light emitting mode of the light source; controlling, if the obtained color signal is a first color signal, the heater to be turned on, where the first color signal is configured to indicate that the aerosol generating product is inserted into the chamber in position; and/or controlling, if the obtained color signal is a second color signal, the heater to be turned off, where the second color signal is configured to indicate that the aerosol generating product is removed from the chamber.

In some embodiments, the aerosol generating device further includes a dust-proof cover, and the obtaining a turn-on signal of the light source includes: obtaining the turn-on signal of the light source based on a position state of the dust-proof cover.

In some embodiments, in the intermittent light emitting mode, the light source emits light at an interval of 100 ms to 1 s, and a duration of each light emission of the light source is 10 ms to 20 ms.

According to a second aspect of this application, an aerosol generating device is further provided. The aerosol generating device includes a light source, a color sensor, a processor, and a memory storing instructions, and the instructions, when executed by the processor, causes the aerosol generating device to perform the method according to the first aspect.

In some embodiments, a printed circuit board of the light source is an aluminum-based circuit board; and the aluminum-based circuit board includes an aluminum-based layer and a copper foil layer arranged on the aluminum-based layer, and a thickness range of the copper foil layer is 70 μm to 105 μm.

According to a third aspect of this application, an aerosol generating system is further provided. The system includes an aerosol generating product and the aerosol generating device according to the second aspect.

It should be understood that, contents described in the summary of the present invention are not intended to define the key or important features of the present invention, and are not intended to limit the scope of the present invention. Other features of the present invention are easily understood through the following descriptions.

### BRIEF DESCRIPTION OF THE DRAWINGS

To describe the technical solutions in the embodiments of the present invention more clearly, the following briefly describes the accompanying drawings required in the embodiments of the present invention. Apparently, the accompanying drawings in the following descriptions show merely some embodiments of the present invention, and a person skilled in the art may still derive other drawings from these accompanying drawings without creative efforts.

FIG. 1 is a schematic structural diagram of an aerosol generating system according to some embodiments of this application;

FIG. 2 is a schematic structural diagram of an aerosol generating system according to some other embodiments of this application;

FIG. 3 is a flowchart of a control method for an aerosol generating device according to some embodiments of this application;

FIG. 4 is a flowchart of a control method for an aerosol generating device according to some embodiments of this application; and

FIG. 5 is a schematic diagram of a hardware structure of a controller of an aerosol generating device according to some embodiments of this application.

### DETAILED DESCRIPTION

The principle and spirit of the present invention are described below with reference to several exemplary embodiments shown in the accompanying drawings. It should be understood that, these specific embodiments are described only to enable a person skilled in the art to better understand and implement the present invention, but are not intended to limit the scope of the present invention in any manner. In the following descriptions and claims, unless otherwise defined, all technical and scientific terms used in this specification have meanings commonly understood by a person skilled in the art.

The terms “include” and similar terms used in this specification should be understood as open include, that is, “include but are not limited to”. The term “based on” should be understood as “at least partially based on”. The term “an embodiment” or “this embodiment” should be understood as “at least one embodiment”. The term “first”, “second”, and the like may refer to different or same objects, are only used to distinguish the referred objects, and do not imply a particular spatial sequence, a time sequence, an importance sequence, and the like of the referred objects.

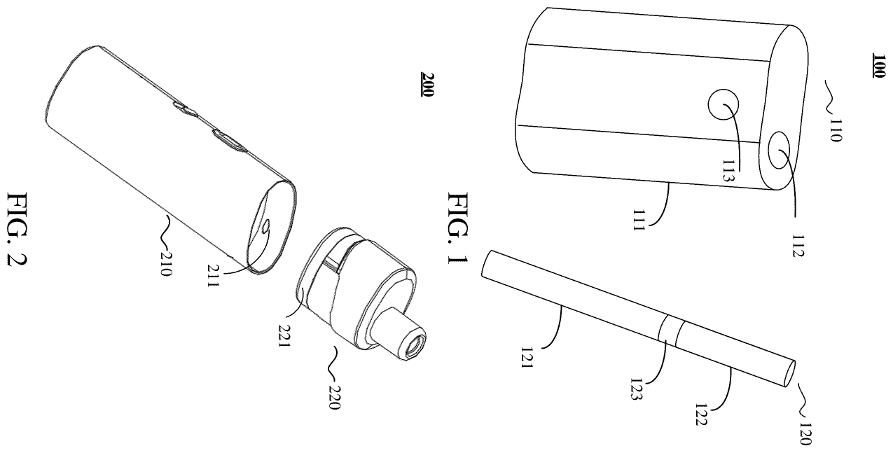

FIG. 1 shows an example of an application scenario of some embodiments of this application. As shown in FIG. 1, an aerosol generating system 100 includes an aerosol generating device 110 and an aerosol generating product 120. The aerosol generating device 110 includes a housing 111, a chamber, an atomization element, and a color detection device. The housing 111 is provided with an opening 112. The aerosol generating device 110 has a chamber that can accommodate the aerosol generating product 120, and the aerosol generating product 120 may be inserted into the chamber or removed from the chamber through the opening 112. Specifically, the chamber may be in communication with the outside through the opening 112. The color detection device is configured to detect an insertion situation or a removal situation of the aerosol generating product 120 in the chamber.

The aerosol generating product 120 generates an aerosol under an action of the atomization element. The atomization element may be any suitable element capable of causing a solid-state aerosol forming substrate to generate an aerosol. For example, the atomization element may be specifically a heater or an ultrasonic vibration atomization element. The heater is configured to heat at least a part of the aerosol generating product 120 inserted into the chamber of the aerosol generating device 110, to generate an aerosol for inhalation.

In some embodiments, the aerosol generating device 110 further includes an input module, and the input module is configured to receive a light source turn-on instruction inputted by a user, to generate a turn-on signal of the light source. Specifically, the input module may be a key 113, and the user may input the light source turn-on instruction by pressing the key 113. In some embodiments of this application, the input module may also be a state sensor of a dust-proof cover. The dust-proof cover includes a cover body and a connection portion. The cover body is connected to the housing 111 through the connection portion, and an edge of the cover body is provided with a buckle structure matching the opening 112. The cover body may be pressed into the opening 112, to separate the chamber from the external environment, to achieve a dust-proof effect. When the state sensor of the dust-proof cover identifies that the dust-proof cover is opened, the chamber is in communication with the outside through the opening 112. The user may input the light source turn-on instruction by opening the dust-proof cover.

The aerosol generating device 110 further includes a controller, and the controller is in communication connection with the heater and the color detection device. The controller can control not only the color detection device and the heater, but also another element (such as a power supply) in the aerosol generating device 110.

Specifically, the color detection device includes the light source and the color sensor. The light source is configured to emit incident light into the chamber of the aerosol generating device 110. The color sensor is configured to detect reflected light of the incident light, to generate a color signal. The light source may be a light source of any suitable type. For example, in some embodiments, the light source may be an LED light. The color sensor may specifically include a color filter and an optical-to-electrical detector. The controller detects, through the color filter and the optical-to-electrical detector, a color in the reflected light of the incident light emitted by the light source, and generates a corresponding color signal. The light source and the color sensor may be independently arranged, or may be integrated.

As shown in FIG. 1, in some embodiments, the aerosol generating product 120 includes a solid substrate segment 121 and a filter segment 122. An outer surface of the filter segment 122 at a junction with the solid substrate segment 121 has a label 123. A position at which the color sensor is arranged corresponds to the label 123 of the aerosol generating product 120 when the aerosol generating product 120 is inserted into the chamber of the aerosol generating device 110 in position. The solid-state substrate segment 121 includes the solid-state aerosol forming substrate. The aerosol forming substrate is a substrate that can release volatile compound that can form an aerosol. The volatile compound may be released by heating the aerosol forming substrate. An aerosol generated by heating the solid substrate segment 121 is delivered to the user through the filter segment 122, and the filter segment 122 may be a cellulose acetate filter.

A color of the label 123 may be a single color such as red, blue, and green, or may be a mixed color. The color of the label 123 may represent different types (for example, different flavors) of the aerosol generating product 120, for example, red represents a mint-flavor aerosol generating product 120, blue represents a coffee-flavor aerosol generating product 120, green represents a mango-flavor aerosol generating product 120, and the like. The color of the label 123 is different from a color of the outer surface of the solid substrate segment 121, to facilitate detection and identification of the color detection device.

Specifically, in some embodiments, the outer surface of the solid-state substrate segment 121 of the aerosol generating product 120 has a first color, an outer surface of the label 123 has a second color, and an inner wall of the chamber of the aerosol generating device 110 has a third color. In a process of inserting or removing the aerosol generating product from the chamber, the position of the aerosol generating product in the chamber changes, and a reflection interface of the incident light emitted by the light source also changes. The reflected light may be reflected by an inner wall of the chamber, or may be reflected by an outer surface of the aerosol generating product. When the reflected light is reflected by reflection interfaces of different colors, the color sensor can correspondingly generate different color signals when detecting colors in the reflected light.

FIG. 2 shows an example of an application scenario of some other embodiments of this application. As shown in FIG. 2, an aerosol generating system 200 includes an aerosol generating device 210 and an aerosol generating product 220. The aerosol generating device 210 includes a color sensor 211. In some embodiments, the aerosol generating product 220 includes an atomizer, a liquid storage tank and a liquid-state aerosol forming substrate arranged in the liquid storage tank are arranged in the atomizer. In some embodiments, a heat element is further arranged in the atomizer, and is configured to heat and atomize the liquid-state aerosol forming substrate. In some embodiments, the heat element is not arranged in the atomizer, and only has a liquid storage function, to cooperate with an external heat element to heat and atomize the liquid-state aerosol forming substrate in the atomizer. In the foregoing embodiment of the atomizer, an outer surface of the housing of the aerosol generating product 220 has the first color, a label 221 is further arranged on a part of the outer surface of the housing, and the label 221 has the second color. In some embodiments, an ultrasonic atomization element is further arranged in the atomizer, to perform ultrasonic atomization on the liquid-state aerosol forming substrate.

When the aerosol generating product 120 is not inserted into the chamber, the incident light emitted by the light source may be illuminated on the inner wall of the chamber, and the color sensor may detect the third color of the inner wall of the chamber, and generate a color signal corresponding to the third color. When the aerosol generating product 120 is inserted into the chamber through the opening 112, the incident light emitted by the light source may be illuminated on the aerosol generating product 120. First, the color sensor may detect the first color of the outer surface of the solid substrate segment 121, and generate a signal corresponding to the first color. In addition, when the aerosol generating product 120 is inserted into the chamber in position, the color sensor may detect the second color of the outer surface of the label 123, and generate a color signal corresponding to the second color. When the aerosol generating product 120 is not inserted into the chamber in position, the color sensor only generates the color signal corresponding to the first color. When the aerosol generating product 120 is removed from the chamber through the opening 112, the incident light emitted by the light source 201 may be illuminated sequentially on the external surface of the solid-state substrate segment 121 and the internal wall of the chamber, and the color sensor sequentially generates the color signal corresponding to the first color and the color signal corresponding to the third color. Therefore, the color signal may reflect an insertion situation or a removal situation of the aerosol generating product 120 in the chamber.

In some embodiments, if the color sensor detects the second color alone, it indicates that the aerosol generating product is inserted into the chamber in position. If the color sensor does not detect the second color, it indicates that the aerosol generating product is not inserted into the chamber in position or the aerosol generating product is removed from the chamber. In this embodiment, the insertion situation or the removal situation of the aerosol generating product in the chamber may be preliminarily determined only based on a detection situation of whether to detect the second color (that is, whether the second color is detected).

In a process in which the color detection device detects the insertion or removal situation of the aerosol generating product 120, a continuous light emitting mode may be used as an operating mode of the light source. However, luminous efficiency of the light source decreases with an increase of use time. Specifically, after the use time reaches a specific threshold, luminous power decreases rapidly, resulting in a decrease of luminous intensity. The luminous intensity is reduced, resulting in unstable luminance of the light source, and further reducing accuracy of detecting the color by the color detection device. In the manner of continuously emitting light by the light source, not only power consumption is wasted, but also a service life of the light source is shortened. Based on this, embodiments of this application provide a control method for an aerosol generating device, and an aerosol generating device and system. The aerosol generating device can control a light source to emit light in an intermittent light emitting mode during at least a part of time after the light source is turned on, to prevent the light source from continuously emitting light after the light source is turned on, thereby reducing a light emitting time of the light source. For ease of understanding the present invention by a reader, descriptions are provided below with reference to specific embodiments.

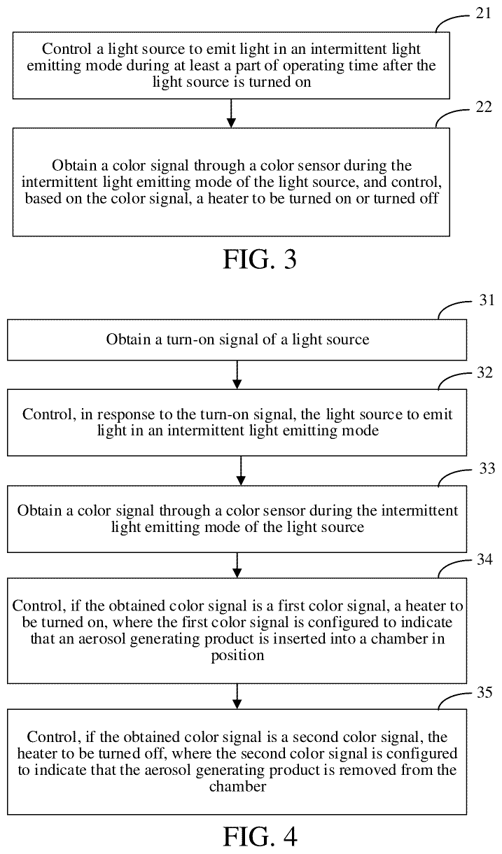

Referring to FIG. 3, embodiments of this application provide a control method for an aerosol generating device, and the method is applied to an aerosol generating device. As shown in FIG. 3, the method includes the following steps.

Step 21: Control a light source to emit light in an intermittent light emitting mode during at least a part of operating time after the light source is turned on.

In this embodiment, a light emitting mode of the light source includes the intermittent light emitting mode. A controller may control the light source to emit light in the intermittent light emitting mode during at least a part of time after the light source is turned on, to prevent the light source from continuously emitting light to the outside after the light source is turned on.

Specifically, in the intermittent light emitting mode, the controller controls the light source to emit light at a preset light emitting time interval, that is, the light source suspends emitting light for a period of time after emitting light for a period of time. The light emitting time interval in this embodiment of this application refers to a time interval between two adjacent light emissions of the light source. In some embodiments, when the light emitting time interval of the light source is 100 ms to 1 s, and a duration for which the light source emits light once is specifically 10 ms to 20 ms, a light emitting time of the light source can be effectively reduced without affecting detection accuracy of a color sensor. If the light emitting time interval is excessively long or the duration of once light emission is excessively short, detection of an insertion situation or a removal situation of the aerosol generating product by the color sensor is easily missed. If the light emitting time interval is excessively short or the duration of light emitting is excessively long, the light emitting time of the light source cannot be effectively reduced. A person skilled in the art may set the light emitting time interval of the light source and the duration for which the light source emits light once according to an actual situation. For example, the light source may emit light at an interval of 100 ms, and a duration of each light emission is 10 ms.

In some embodiments, the light emitting mode of the light source may further include a continuous light emitting mode. In the continuous light emitting mode, the controller controls the light source to continuously emit light to the outside. When the light source is turned on, the light emitting mode of the light source may be the continuous light emitting mode, or may be the intermittent light emitting mode. For example, in some embodiments, the controller may receive a turn-on signal of the light source, and control, in response to the turn-on signal of the light source, the light source to emit light in the intermittent light emitting mode. In some other embodiments, the controller may alternatively receive the turn-on signal of the light source, and control, in response to the turn-on signal of the light source, the light source to emit light in the continuous light emitting mode.

In some embodiments, step 21 further includes the following steps.

Step 211: Obtain a color signal through a color sensor.

Step 212: If the obtained color signal is a first color signal, control a heater to be turned on, and control the light source to emit light in the intermittent light emitting mode, where the first color signal is configured to indicate that an aerosol generating product is inserted into a chamber in position.

In some embodiments, the controller may obtain the color signal through the color sensor, and adjust the light emitting mode of the light source based on the color signal.

In some embodiments, when the light source is turned on, the light source emits light in the continuous light emitting mode, and if the controller obtains the first color signal, the controller controls the heater to be turned on, and adjusts the light emitting mode of the light source from the current continuous light emitting mode to the intermittent light emitting mode. Specifically, the first color signal is configured to indicate that the aerosol generating product is inserted into the chamber in position. In this embodiment, the controller controls the light source to continuously emit light before the light source is turned on until the controller detects that the aerosol generating product is inserted into the chamber in position, to improve detection precision of the color sensor. After the controller detects that the aerosol generating product is inserted into the chamber in position, the controller controls the heater to be turned on, and controls the light source to emit light intermittently, to reduce the light emitting time of the light source.

Specifically, in some embodiments, the controller controls the light source to be turned on only in a process in which the heater performs heating. When the heater starts to perform heating, the controller may control the light source to be turned on at the same time. The controller may alternatively control the light source to be turned on after the heater starts to perform heating. For example, in some embodiments of this application, the controller may obtain a running state of the heater, and if the heater is in a turn-on state, the controller controls the light source to be turned on. In this embodiment, the color sensor may be used only to detect a process of removing the aerosol generating product from the chamber, but is not configured to detect a process of inserting the aerosol generating product into the chamber.

Specifically, in some embodiments, the first color signal may be a color signal correspondingly generated when the color sensor detects a second color of a label segment, that is, as long as the color sensor detects a color of the label segment, it indicates that the aerosol generating product is inserted into the chamber in position. In some other embodiments, to more accurately determine whether the aerosol generating product is inserted into the chamber in position, the first color signal may alternatively be a color signal corresponding to the first color and a color signal corresponding to the second color that are sequentially obtained within a first preset duration. In other words, if the color sensor sequentially detects a color of an outer surface of a solid-state substrate segment and the color of the label segment within the first preset duration, it indicates that the aerosol generating product is inserted into the chamber in position.

In some embodiments, step 212 specifically includes the following steps: synchronously controlling, by the controller, the heater to be turned on, and controlling the light source to emit light in the intermittent light emitting mode; or controlling, by the controller, the heater to be turned on, and controlling the light source to emit light in the intermittent light emitting mode within a preset first duration threshold when the heater is turned on.

In this embodiment, the controller may control the light source to emit light in the intermittent light emitting mode while turning on the heater. The controller may alternatively control the light source to emit light in the intermittent light emitting mode within the preset first duration threshold after the heater is turned on. In this embodiment, the light emitting time of the light source can be reasonably reduced in a process in which the heater heats the aerosol generating product.

Step 22: Obtain a color signal through a color sensor during the intermittent light emitting mode of the light source, and control, based on the color signal, a heater to be turned on and/or turned off.

In some embodiments, step 22 specifically includes the following steps.

Step 221: Obtain the color signal through the color sensor during the intermittent light emitting mode of the light source.

Step 222: If the obtained color signal is a second color signal, control the heater to be turned off, and control the light source to be turned off, where the second color signal is configured to indicate that the aerosol generating product is removed from a chamber.

In this embodiment, the controller obtains the color signal through the color sensor during the intermittent light emitting mode of the light source; and if the second color signal is obtained, the controller controls the heater to be turned off, and controls the light source to be turned off, where the second color signal is configured to indicate that the aerosol generating product is removed from the chamber. For example, the second color signal may be specifically the color signal corresponding to the first color and a color signal corresponding to a third color that are sequentially obtained within a second preset duration. In other words, if the color sensor sequentially detects the color of the outer surface of the solid-state substrate segment and the color of the chamber within the second preset duration, it indicates that the aerosol generating product is removed from the chamber.

Specifically, in some embodiments, step 222 includes the following steps.

Step 2221: Synchronously control the heater to be turned off, and control the light source to be turned off; or control the heater to be turned off, and control the light source to be turned off within a preset second duration threshold when the heater is turned on.

In some embodiments, the controller may control the light source to be turned off while controlling the heater to be turned off. In this embodiment, if the aerosol generating product is removed from the chamber, the heater and the light source are turned off at the same time. A user needs to turn on the light source again when needing to inhale the aerosol generating product next time.

In some other embodiments, to facilitate the user to continuously inhale the aerosol generating product, the controller may alternatively control the light source to be turned off within the preset second duration threshold after the heater is controlled to be turned off. In this embodiment, if the aerosol generating product is removed from the chamber, the controller controls the heater to be first turned off. However, the light source is not turned off immediately after the heater is turned off, but continues to emit light. When the user continues to use the aerosol generating product within the preset second duration threshold after the heater is turned off, the user does not need to turn on the light source again, thereby facilitating continuous inhalation of the aerosol generating product. If no aerosol generating product is inserted within the preset second duration threshold after the heater is turned off, the controller controls the light source to be turned off.

Specifically, referring to FIG. 4, in some embodiments, the foregoing method specifically includes the following steps.

Step 31: Obtain a turn-on signal of a light source.

Step 32: Control, in response to the turn-on signal, the light source to emit light in an intermittent light emitting mode.

In some embodiments, the controller may specifically obtain the turn-on signal of the light source based on a position state of the dust-proof cover. If the position state of the dust-proof cover is an open position state (that is, when the dust-proof cover is opened), the controller obtains the turn-on signal of the light source. After obtaining the turn-on signal of the light source, the controller controls, in response to the turn-on signal, the light source to emit light in the intermittent light emitting mode.

Step 33: Obtain a color signal through a color sensor during the intermittent light emitting mode of the light source.

Step 34: Control, if the obtained color signal is a first color signal, a heater to be turned on, where the first color signal is configured to indicate that an aerosol generating product is inserted into a chamber in position.

Step 35: Control, if the obtained color signal is a second color signal, the heater to be turned off, where the second color signal is configured to indicate that the aerosol generating product is removed from the chamber.

In some embodiments, during the intermittent light emitting mode of the light source, if the controller obtains the first color signal, the controller controls the heater to be turned on. In this embodiment, the color sensor may be at least configured to detect whether the aerosol generating product is inserted into the chamber in position.

In some other embodiments, during a period in which the light source emits light in the intermittent light emitting mode, if the controller obtains the second color signal, the controller controls the heater to be turned off. In this embodiment, the color sensor may be at least configured to detect a process in which the aerosol generating product is removed from the chamber.

In some embodiments, during a period in which the light source emits light in the intermittent light emitting mode, the color sensor detects both an insertion process and a removal process of the aerosol generating product in the chamber. If the controller obtains the first color signal, the controller controls the heater to be turned on. If the controller obtains the second color signal, the controller controls the heater to be turned off. The aerosol generating device may control the light source to emit light in the intermittent light emitting mode after the light source is turned on. In addition, the aerosol generating device may detect, through the color sensor, that the aerosol generating product is inserted into or removed from the chamber, to control the heater to be turned on or turned off. In this embodiment of this application, the light source may only use the intermittent light emitting mode. Compared with a case in which an operating mode of the light source only uses the continuous light emitting mode, this embodiment of this application can prevent the light source from continuously emitting light to the outside, thereby reducing a power-on duration of the light source, which is beneficial to maintaining stable luminance of the light source for a long time, extending a service life of the light source, and reducing power consumption.

In some embodiments, the foregoing method further includes the following steps:
recording, by the aerosol generating device, a heating duration of the heater after the heater starts to perform heating; and if the heating duration exceeds a preset heating duration threshold, controlling the heater to be turned off, and controlling the light source to be turned off.

In this embodiment, the preset heating duration may be a total duration required to complete one heating of the aerosol generating product, for example, 200 seconds. If the heating duration exceeds the preset heating duration threshold, the controller determines that heating of the aerosol generating product is completed, thereby controlling the heater to stop heating, and controlling the light source to be turned off to reduce the light emitting time of the light source. Because the controller can automatically control the light source to be turned off after heating of the aerosol generating product is completed, and the user does not need to manually turn off the light source. This embodiment can simplify a user operation and improve user experience.

In some embodiments, the method specifically further includes the following steps:
if the obtained color signal only includes a third color signal, and a total duration for which the third color signal is obtained is greater than a third preset duration threshold, controlling, by the aerosol generating device, the heater to be turned off, and controlling the light source to be turned off, where the third color signal is configured to indicate that the aerosol generating product is not inserted into the chamber in position. The third color signal may be specifically a color signal corresponding to the first color, that is, if the color sensor only detects the color of the outer surface of the solid-state substrate segment, it indicates that the aerosol generating product is not inserted into the chamber in position.

In this embodiment, if the controller only obtains the third color signal within the preset duration, the controller may determine that the aerosol generating product is not inserted into the chamber in position, and the controller calculates a duration (that is, the controller calculates the total duration for which the third color signal is obtained) for which the aerosol generating product is not inserted into the chamber in position. If the total duration for which the third color signal is obtained is greater than the third preset duration threshold, the aerosol generating device controls the heater to be in an off state, and controls the light source to be turned off. The third preset duration threshold may be, for example, two minutes to five minutes. In this embodiment, the controller may automatically control the light source to be turned off when a duration for which the aerosol generating product is not inserted into the chamber in position is too long, to reduce the light emitting time of the light source.

In some embodiments, the method specifically further includes the following steps:
if the obtained color signal only includes the third color signal and the total duration for which the third color signal is obtained is greater than a fourth preset duration threshold and is not greater than the third preset duration threshold, controlling, by the aerosol generating device, the heater to be in the off state, and controlling the light source to emit light intermittently, where the third preset duration threshold is greater than the fourth preset duration threshold.

In this embodiment, when the aerosol generating product is not inserted into the chamber in position for a long time, the aerosol generating device can control the light source to emit light intermittently, to wait for the user to insert the aerosol generating product into the chamber in position, thereby reducing the light emitting time of the light source.

For example, the fourth preset duration threshold may be one minute to two minutes. Specifically, for example, the fourth preset duration threshold may be one minute, and the third preset duration threshold may be five minutes. When the light source is turned on, the controller controls the light source to emit light continuously. If the controller only obtains the third color signal within a third preset duration, when the total duration for which the third color signal is obtained is greater than one minute but not greater than five minutes, the controller can control the light source to emit light intermittently. When the total duration for which the third color signal is obtained is greater than five minutes, the controller can control the light source to be turned off.

In some embodiments, the method specifically further includes the following steps:
if the controller obtains a fourth color signal, controlling, by the controller, the heater to be turned off, and controlling the light source to be turned off, where the fourth color signal is configured to indicate that the aerosol generating product does not match the aerosol generating device.

In this embodiment, the fourth color signal may be specifically the color signal corresponding to the first color and a color signal corresponding to a fourth color that are sequentially obtained within a fourth preset duration. In this embodiment, the color of the label segment of the aerosol generating product that matches the aerosol generating device is the second color. The fourth color and the second color have different hues. The fourth color is a color of an outer surface of a label of another aerosol generating product. If the color detection device sequentially detects the first color and the fourth color within the fourth preset duration, the controller may determine that the aerosol generating product inserted into the chamber does not match the aerosol generating device, and control the light source to be turned off, to reduce the light emitting time of the light source. In this embodiment, the controller may further feed back prompt information (such as vibration, light, or sound) through an alarm device (such as a motor, a speaker, or a camera flash), where the prompt information is configured to indicate that the aerosol generating product does not match the aerosol generating device.

In some embodiments, the method specifically further includes the following steps:
if a color signal obtained within a fifth preset duration only includes a fifth color signal, controlling the heater to be in the off state, and controlling the light source to be turned off, where the fifth color signal is configured to indicate that no aerosol generating product is inserted, that is, if the color sensor only detects a color of the chamber within the fifth preset duration, it indicates that no aerosol generating product is inserted.

In this embodiment, the fifth color signal may be specifically the color signal corresponding to the third color. If the color signal obtained by the controller within the fifth preset duration only includes the color signal corresponding to the third color, the controller may determine that no aerosol generating product is inserted into the chamber. The controller may control the light source to be turned off after the light source is turned on and no aerosol generating product is inserted for a long time, thereby reducing the light emitting time of the light source.

A fault of the light source is mostly caused by an excessively high temperature of the light source. A temperature of the light source is the most important factor affecting light decay. The temperature of the light source depends on heat dissipation of the light source, the power-on duration of the light source, voltage and current passing through the light source, and a temperature of the environment. Therefore, in addition to reducing the light emitting duration of the light source, light intensity of the light source may be increased to implement long-term stability of the light intensity of the light source. In some embodiments, to improve a heat dissipation effect of the light source, the following solution may be used: first, during a manufacturing process of a printed circuit board (PCB) of the light source, a thickness of copper cladding is increased, so that a heat dissipation coefficient is increased. In this embodiment, when a copper thickness of a copper foil layer of the PCB is two ounces to three ounces, the heat dissipation effect of the light source is good, where a copper thickness of one ounce refers to that the thickness of the copper foil layer is 35 μm, and a copper thickness of the copper foil layer of two ounces to three ounces refers to that a thickness range of the copper foil layer is 70 μm to 105 μm. In addition, in some embodiments, a material of a substrate of the PCB may be an aluminum substrate. The aluminum substrate has a relatively high heat dissipation coefficient, and can effectively improve the heat dissipation effect of the light source.

In this embodiment of this application, the outer surface of the aerosol generating product has the first color and the second color, the chamber of the aerosol generating device receives or removes the aerosol generating product through the opening, and the inner wall of the chamber of the aerosol generating device has the third color. In a process of inserting the aerosol generating product into the chamber or removing the aerosol generating product from the chamber, the position of the aerosol generating product in the chamber changes, causing a change of a light reflection interface. The reflected light may be reflected by the inner wall of the chamber, or may be reflected by the outer surface of the aerosol generating product. When the reflected light is reflected by reflection interfaces of different colors, the color sensor can correspondingly generate different color signals when detecting the reflected light. Therefore, based on different color signals, the aerosol generating device may detect that the aerosol generating product is inserted into or removed from the chamber, to control, by controlling the operating mode of the light source, the light source to emit light intermittently or be turned off. In other words, the aerosol generating device can automatically control, based on the color signal, the light source to intermittently emit light or to be turned off. Therefore, it can prevent the light source from continuously emitting light to the outside, which is beneficial to maintaining long-term stability of the light source, extending a service life of the light source, and reducing power consumption. In addition, the user does not need to manually adjust the operating mode of the light source, so that a user operation can be simplified and user experience can be improved.

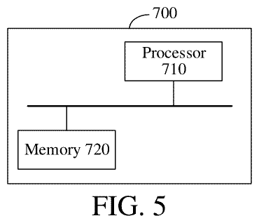

FIG. 5 is a schematic diagram of a hardware structure of a controller. As shown in FIG. 5, a controller 700 includes:
one or more processors 710 and a memory 720. In FIG. 5, one processor 710 is used as an example.

The processor 710 and the memory 720 may be connected through a bus or in another manner. In FIG. 5, a bus connection is used as an example.

The memory 720 is used as a non-volatile computer-readable storage medium, and may be configured to store a non-volatile software program, a non-volatile computer executable program, and a module, such as program instructions/a module corresponding to the method in this embodiment of this application. The processor 710 executes the non-volatile software program, the instructions and the module stored in the memory 720 to execute various functional applications and data processing of the aerosol generating device, that is, to implement the method of the foregoing method embodiments.

The memory 720 may include a program storage area and a data storage area. The program storage area may store an operating system and an application program required by at least one function. The data storage area may store data created based on use of the aerosol generating device, and the like. In addition, the memory 720 may include a high-speed random access memory, and may further include a non-volatile memory, such as at least one magnetic disk storage device, a flash storage device, or another non-volatile solid-state storage device. In some embodiments, the memory 720 may optionally include a memory remotely arranged relative to the processor 710. Examples of the foregoing network include, but are not limited to, an internet, an intranet, a local area network, a mobile communication network, and a combination thereof.

The one or more modules are stored in the memory 720, and when executed by the one or more processors 710, perform the method in any of the foregoing method embodiments, for example, perform the method steps 21 and 22 in FIG. 3 and the method steps 31 to 35 in FIG. 4 that are described above.

The foregoing product may execute the method provided in the embodiments of this application, and has corresponding functional modules and beneficial effects for executing the method. For technical details not described in this embodiment, refer to the method provided in this embodiment of this application.

Embodiments of this application provide a non-volatile computer-readable storage medium. The computer-readable storage medium stores computer executable instructions. The computer executable instructions are executed by one or more processors, for example, the processor 710 in FIG. 5. The one or more processors may be enabled to perform the method in any of the foregoing method embodiments, for example, perform the method steps 21 and 22 in FIG. 3 and the method steps 31 to 35 in FIG. 4 that are described above.

The described device embodiments are merely exemplary. The units described as separate components may or may not be physically separate, and components displayed as units may or may not be physical units, may be located in one place, or may be distributed on a plurality of network units. Some or all of the modules may be selected based on actual requirements to implement the objectives of the solutions of this embodiment.

Based on the foregoing descriptions of the implementations, a person skilled in the art may clearly understand that the implementations may be implemented by using software and a universal hardware platform, or by using hardware certainly. A person of ordinary skill in the art may understand that all or some of the processes of the methods in the embodiments may be implemented by indicating related hardware through a program. The program may be stored in a computer-readable storage medium. When the program is executed, the computer-readable instructions may include the processes of the foregoing method embodiments. The storage medium may be a magnetic disk, an optical disc, a read-only memory (ROM), a random access memory (RAM), or the like.

In conclusion, it should be noted that, the foregoing embodiments are merely used for describing the technical solutions of the present invention, but are not intended to limit the technical solutions of the present invention. In the idea of the present invention, technical features of the foregoing embodiments or different embodiments may also be combined, steps may be implemented in any sequence, and many other variations exist in different aspects of the present invention as described above. For brevity, they are not provided in detail. Although the present invention is described in detail with reference to the foregoing embodiments, it should be understood by a person skilled in the art the technical solutions described in the foregoing embodiments can still be modified, or some or all of technical features can be replaced by equivalents. However, these modifications or replacements do not cause the essence of corresponding technical solutions to depart from the scope of the technical solutions of the embodiments of the present invention.

1. A control method for an aerosol generating device, wherein the aerosol generating device comprises a housing, a light source, and a color sensor, the housing is provided with an opening, the aerosol generating device receives or removes an aerosol generating product through the opening, the aerosol generating product is configured to generate an aerosol under an action of an atomization element, the light source is configured to emit light, and the color sensor is configured to detect a reflected light of the emitted light to generate a color signal; and
the method comprises:
controlling the light source to emit light in an intermittent light emitting mode during at least a part of operating time after the light source is turned on; and
obtaining the color signal through the color sensor during the intermittent light emitting mode of the light source, and controlling, based on the color signal, a heater to be turned on and/or turned off.

2. The method according to claim 1, wherein the aerosol generating product comprises a solid-state aerosol forming substrate, the atomization element comprises the heater, a chamber configured to accommodate the aerosol generating product is arranged in the housing, and the heater is configured to heat the aerosol generating product received in the chamber, to enable the solid-state aerosol forming substrate to generate an aerosol; and
the controlling the light source to emit light in an intermittent light emitting mode during at least a part of operating time after the light source is turned on comprises:
obtaining the color signal through the color sensor; and
if the obtained color signal is a first color signal, controlling the heater to be turned on, and controlling the light source to emit light in the intermittent light emitting mode, wherein the first color signal is configured to indicate that the aerosol generating product is inserted into the chamber in position.

3. The method according to claim 2, wherein the controlling the heater to be turned on, and controlling the light source to emit light in the intermittent light emitting mode comprises:
synchronously controlling the heater to be turned on and controlling the light source to emit light in the intermittent light emitting mode; or
controlling the heater to be turned on, and controlling the light source to emit light in the intermittent light emitting mode within a preset first duration threshold when the heater is turned on.

4. The method according to claim 3, wherein the obtaining the color signal through the color sensor during the intermittent light emitting mode of the light source, and controlling, based on the color signal, a heater to be turned on and/or turned off comprises:
obtaining the color signal through the color sensor during the intermittent light emitting mode of the light source; and
if the obtained color signal is a second color signal, controlling the heater to be turned off, and controlling the light source to be turned off, wherein the second color signal is configured to indicate that the aerosol generating product is removed from the chamber.

5. The method according to claim 4, wherein the controlling the heater to be turned off, and controlling the light source to be turned off comprises:
synchronously controlling the heater to be turned off, and controlling the light source to be turned off; or
controlling the heater to be turned off, and controlling the light source to be turned off within a preset second duration threshold when the heater is turned on.

6. The method according to claim 1, wherein the aerosol generating product comprises a solid-state aerosol forming substrate, the atomization element comprises a heater, a chamber configured to accommodate the aerosol generating product is arranged in the housing, and the heater is configured to heat the aerosol generating product received in the chamber, to enable the solid-state aerosol forming substrate to generate an aerosol;
the controlling the light source to emit light in an intermittent light emitting mode during at least a part of operating time after the light source is turned on comprises:
obtaining a turn-on signal of the light source; and
controlling, in response to the turn-on signal, the light source to emit light in the intermittent light emitting mode; and
the obtaining the color signal through the color sensor during the intermittent light emitting mode of the light source, and controlling, based on the color signal, a heater to be turned on and/or turned off comprises:
obtaining the color signal through the color sensor during the intermittent light emitting mode of the light source; and
controlling, if the obtained color signal is a first color signal, the heater to be turned on, wherein the first color signal is configured to indicate that the aerosol generating product is inserted into the chamber in position; and/or
controlling, if the obtained color signal is a second color signal, the heater to be turned off, wherein the second color signal is configured to indicate that the aerosol generating product is removed from the chamber.

7. The method according to claim 6, wherein the aerosol generating device further comprises a dust-proof cover; and
the obtaining a turn-on signal of the light source comprises:
obtaining the turn-on signal of the light source based on a position state of the dust-proof cover.

8. The method according to claim 1, wherein in the intermittent light emitting mode, the light source emits light at an interval of 100 ms to 1 s, and a duration of each light emission of the light source is 10 ms to 20 ms.

9. An aerosol generating device, comprising a light source, a color sensor, a processor, and a memory storing instructions, and the instructions, when executed by the processor, causing the aerosol generating device to perform the method according to claim 1.

10. The device according to claim 9, wherein a printed circuit board of the light source is an aluminum-based circuit board; and
the aluminum-based circuit board comprises an aluminum-based layer and a copper foil layer arranged on the aluminum-based layer, and a thickness range of the copper foil layer is 70 μm to 105 μm.

11. An aerosol generating system, comprising:
an aerosol generating product and the aerosol generating device according to claim 9 or 10.
